(19) United States
(12) Patent Application Publication
(10) Pub. No.: US 2006/0158976 A1
(43) Pub. Date: Jul. 20, 2006

(54) Magneto-optical disc device and method for writing data on magneto-optical disc

(75) Inventors: Syouji Fukunaga, Kato-gun (JP); Takahiro Nakano, Kato-gun (JP); Tetsuo Maruyama, Kato-gun (JP)

Correspondence Address: Patrick G. Burns, Esq.;GREER, BURNS & CRAIN, LTD., Suite 2500, 300 South Wacker Dr., Chicago, IL, 60606, US

(73) Assignee: FUJITSU LIMITED

(21) Appl. No.: 11/366,173

(22) Filed: Mar. 2, 2006

Related U.S. Application Data
(63) Continuation of application No. PCT/JP03/11398, filed on Sep. 5, 2003.

(51) Int. Cl. G11B 11/00; G11B 7/00

(52) U.S. Cl. 369/44.34; 369/13.01

(57) ABSTRACT

A magneto-optical disc device (1) writes data, for each sector, onto a magneto-optical disc (2) using an optical head portion (21) which outputs light onto the magneto-optical disc, at which time the data on the magneto-optical disc (2) is erased and after data is erased, data is written onto the magneto-optical disc (2), and the original data is then verified against the written data for each sector. When verifying the original data against the written data, if a verification error is detected for a sector, position information for the sector on the magneto-optical disc (2) in which a verification error is detected is stored in memory (16). Data verification is continued even when a verification error is detected, and at the end of data verification, data verification is again performed for sectors in which verification errors are detected, based on the position information for sectors stored in memory (16).

### TECHNICAL FIELD

This invention relates to a magneto-optical disc device which writes data to a magneto-optical disc, and a method of writing data to a magneto-optical disc.

### BACKGROUND ART

A magneto-optical disc device is a device which writes data to and reads data from a magneto-optical disc (see for example Japanese Patent Laid-open No. 2002-109837). When a magneto-optical disc device is for example connected to a host computer, upon receiving a write command signal and data for writing from the host computer, the device writes data to a magneto-optical disc as recording media in sectors, which are unit recording regions for data.

A sector is specified by a logical block address, which is a logical address on a magneto-optical disc. A write command signal comprises a logical block address, which indicates the starting position for writing, and a number of continuous sectors for writing from the logical block address.

In magneto-optical disc devices, the so-called optical modulation recording method is generally used. The optical modulation recording method is a method of writing data by irradiating a track on a magneto-optical disc with laser light, and using the intensity of the laser light to change the direction of the magnetization in magnetic domains equivalent to single bits of data. That is, two magnetization directions, forward and reverse, are made to correspond to “1” and “0” respectively, and data is written by changing the direction of magnetization in domains, corresponding to the values of individual bits of data.

In a magneto-optical disc device in which optical modulation recording is used, when data is written to a magneto-optical disc, normally three types of processing are performed: erase processing, write processing, and write verification processing (hereafter called “verify processing”).

Erase processing is processing to change the direction of magnetization in all the magnetic domains in a sector for erasure to the same direction, that is, to write the same value to all the data bits (for example, writing data bits to “0”). In a configuration in which a magnetic field is applied to the magneto-optical disc from above the disc, and laser light is made incident on the lower surface of the magneto-optical disc from below the disc, an upward-directed magnetic field is applied, and the magneto-optical disc is rotated while being irradiated by a high-power laser light beam, to perform the erase processing.

Write processing is processing in which the direction of the magnetization of domains for writing, to which bit data differing from the bit data written in the erase process (in the above example, a “1” data bit), is reversed, to write the data sent from the host computer (data which is a collection of a plurality of data bits).

In write processing, when the optical disc is rotated while applying a downward-directed magnetic field and the position of irradiation of laser light is brought to the position of a domain to which a data bit “1” is to be written, the direction of magnetization in the domain is reversed, and a data “1” is written, by irradiating the magneto-optical disc with laser light at high power. When the position of irradiation of the laser light arrives at the position of a domain to which a data bit “0” is to be written, the disc is irradiated with laser light at low power, so that the direction of magnetization in the domain is not reversed.

Verify processing is processing in which data written in the write processing is read from the magneto-optical disc, and is compared with data sent from the host computer.

However, in this write operation, if a data write operation is performed using laser light with the same power output over a plurality of sectors, depending on the type of magneto-optical disc, errors may occur during execution of verify processing.

When an error occurs during verify processing in the magneto-optical disc device, the verify processing is first interrupted, and verify processing is again executed for the sector at which the error occurred. In this case, if the magneto-optical disc is irradiated with laser light at the same output power to perform verify processing in the magneto-optical disc device, the same error occurs, and so the laser light output power is switched and verify processing is again executed.

FIG. 11 shows an example of an operation procedure in a magneto-optical disc device when data is written to a plurality of sectors allocated to a certain track on a magneto-optical disc.

As is well known, tracks in concentric circle shapes or in a spiral shape, onto which data is to be written, are formed on a magneto-optical disc, and each track (the recording area extending over one circumference of the disc) is divided into a plurality of sectors (data recording unit). A track number is assigned to each track, and a sector number is assigned to each sector.

In the figure, “track M” indicates the track with number M, and “sector N” indicates the sector with number N. In the figure, “number” refers to the number of times the magneto-optical disc has been accessed, “Erase” indicates erase processing, “Write” indicates write processing, and “Verify” indicates verify processing.

As explained above, when data is recorded on a magneto-optical disc using the optical modulation recording method, three types of processing, which are erase processing, write processing, and verify processing, are performed as a set. The magneto-optical disc is accessed once in each of these types of processing, so that in order to perform writing once, the magneto-optical disc is essentially accessed three times.

Each of the numerical values following “Erase”, “Write” and “Verify” indicates the laser light power output; in the figure, the power output is set in three stages, “0”, “1” and “2”. However, even when the numerical values following “Erase”, “Write” and “Verify” are the same, laser light is output at different power levels. That is, the power conditions are set in three different stages for the erase processing, the write processing, and the verify processing, and “0”, “1” and “2” are given as indications of power condition levels for the stages, in order from low to high.

Three stages of power output are prepared for each of the erase processing, write processing and verify processing because, when an error is detected in verify processing during initial recording processing, the laser light output power conditions are changed and verify processing is repeated two more times; if an error is still detected, the laser light power output conditions for erase processing and for write processing are modified, and data recording processing is again performed (second recording processing). For this recording processing also, the laser light power output condition is modified and verify processing is repeated three times, and if an error is still detected, the laser light power output conditions are again modified for erase processing and for write processing, and recording processing is performed yet again (third recording processing).

To explain the above recording processing referring to the example of FIG. 11, first erase processing is performed for sector 1 through sector N (where N is an integer) on the target track, which is the Mth track (where M is an integer), using the “Erase0” power output condition. Then, the magneto-optical disc device returns the optical head to the Mth or target track and performs write processing using the “Write0” power output condition. Thereafter the magneto-optical disc device returns the optical head to the Mth or target track, and performs verify processing using the “Verify0” power output condition. If no errors are detected during this verify processing, the recording processing ends.

However, as indicated in FIG. 11, if an error is detected during the verify processing, the verify processing is interrupted. Then the magneto-optical disc device switches the laser light power output and performs verify processing a prescribed number of times, determined in advance (in FIG. 11, three times), and if no error is detected in this verify processing, the recording processing ends.

In the example of the figure, an error is detected in sector 3 during verify processing using the “Verify0” power output condition, and so verify processing using the “Verify0” power output condition is interrupted, and verify processing using the “Verify1” condition is executed anew; but an error is again detected in sector 3, and so verify processing is executed anew using the “Verify2” power output condition (see the verify processing for “number 3” to “number 5”).

In verify processing retry using the “Verify2” power output condition, no errors are detected in sector 3, and so verify processing for sector 3 ends, and verify processing using the “Verify2” power output condition is continued for sector 4 and subsequent sectors; but an error is detected in sector 5, and so verify processing using the “Verify2” power output condition is interrupted, the laser light power output is modified to “Verify0”, and verify processing is executed anew (see the verify processing for “number 5” and “number 6”).

In the verify processing retry for sector 5, errors are detected at all of the power output conditions, from “Verify0” to “Verify2”, and so when, in the third verify processing retry using the “Verify1” power output condition, an error is detected for sector 5, verify processing is interrupted, and there is a transition to data re-recording processing. That is, the laser light power output condition is modified, and erase processing and write processing are performed (see the verify processing, erase processing, and write processing for “number 7” through “number 9”).

The laser light power output condition is then modified, the re-recorded data is subjected to repeated verify processing (including up to three retries) similar to that described above, and if in this verify processing also errors are detected three consecutive times, similarly to the case described above, the laser light power output condition is again modified, data writing is performed a second time, and verify processing is repeated (including up to three retries) once again for this data, similarly to that described above (see the verify processing, erase processing, and write processing for (“number 11” through “number 19”).

The erase processing and write processing (data rewrite processing) described above, with the laser light power output condition modified, is performed a total of three times, including the initial portion (that is, data write processing using each of the power output conditions “Erase0”, “Write0”, “Erase1”, “Write1”, “Erase2”, “Write2”); if, in verify processing following the second data writing (including up to three retries), an error is detected, the sector in which the error is detected is determined to be a defective sector, and data writing to a sector in another recording area is performed.

In the example of FIG. 11, during the verify processing after the first data rewriting at “Erase1” and “Write1” and retries thereof, errors are detected three times consecutively in sector 6, and so, when an error is detected in sector 6 during the third verify processing retry at the “Verify0” power output condition, the verify processing is interrupted, and there is a transition to modify the laser light power output condition and to again perform data write processing (see the verify processing, erase processing and write processing of “number 12” through “number 14”).

In verify processing and retries thereof following the second data writing, using the “Erase2” and “Write2” power output conditions, an error is again detected in sector 6, and so when an error is detected in sector 6 in the third verify processing retry using the “Verify2” power output condition, a transition is made to processing to change to another sector for the data of sector 6 (see the verify processing, erase processing and write processing of “number 18” through “number 23”). In recording processing following the change to another sector also, the laser light power output conditions are similarly modified in three stages and retries are performed during the erase processing, write processing, and verify processing.

In a magneto-optical disc device of the prior art, when an error occurs during verify processing, the verify processing is interrupted, the laser light power output is switched, and verify processing is again executed from the sector in which the error occurred; hence verify processing is interrupted each time an error occurs, and upon each such occasion the optical head must be positioned at the sector in which the error occurred, so that the magneto-optical disc must be rotated once in order to perform this positioning, and consequently a wait time occurs. Hence there is the problem that the time required for the overall write operation is lengthened. In particular, when the number of error occurrences increases, the number of times verify processing is interrupted also increases, and consequently the rotation wait time is also increased, so that the tendency toward longer processing times becomes prominent.

Also, when erase processing and write processing are again performed, the laser power output is switched for the sector following a sector in which an error has occurred and erase processing and write processing are performed, so that when an error does not occur for erase processing and write processing prior to modification of the laser light power output in the sector following the sector in which the error occurred, the processing is executed despite the fact that there is no need to modify the laser light power output and perform erase processing and write processing.

For example, in the example of FIG. 11, during “revolution 8” and “revolution 9”, erase processing using the “Erase1” power output condition and write processing using the “Write1” power output condition are performed, and during “revolution 13” and “revolution 14”, erase processing using the “Erase2” power output condition and write processing using the “Write2” power output condition are performed; at this time, an error may not occur even if the laser power output is not switched to perform erase processing and write processing for the sector following the sector in which an error has occurred (in the case of “Erase1” and “Write1”, sector 6 through sector N; in the case of “Erase2,” and “Write2”, sector 7 through sector N).

Hence there is the possibility that unnecessary erase processing and write processing is performed for a sector following a sector in which an error has occurred, and in this respect also, the overall time for data writing is lengthened.

### DISCLOSURE OF THE INVENTION

An object of this invention is to provide a magneto-optical disc device, and a method for writing data to a magneto-optical disc, enabling resolution or alleviation of the above problems.

A magneto-optical disc device provided in a first aspect of the invention is a magneto-optical disc device which, when recording data onto a recording area including a plurality of specified sectors on a magneto-optical disc, scans with a head portion used for reading data from and writing data to a magneto-optical disc above the recording area and performs processing to write the data. Then the disc device performs data verification processing to verify the correctness of the data written to the recording area for each sector. Upon detecting an error in the data verification processing, the disc device modifies the output conditions of the head portion in the data write processing and in the data verify processing, and again executes the processing. The magneto-optical disc device comprises:

an error sector position detector for detecting all sectors in which errors occur in the data verify processing, and for storing position information of the sectors on the magneto-optical disc in a memory; and,

a re-execution controller, for re-executing the data write processing and the data verify processing only for sectors in which errors have occurred based on the sector position information stored in the memory.

It is preferable that the magneto-optical disc device comprise an error sector counter for counting the number of sectors in which errors have occurred based on the sector position information stored in the memory during data verify processing, and a judgment unit for comparing the cumulative value of the number of sectors in which errors have occurred counted by the error sector counter with a prescribed reference value set in advance, and for judging whether to halt the data verify process, and that when the judgment unit judges that the data verify processing be halted, the re-execution controller halt the data verify processing, and re-execute the data write processing and data verify processing.

It is preferable that the magneto-optical disc device comprise an error sector computing unit for computing the number of sectors in which errors have occurred per prescribed recording area comprising a plurality of sectors, based on the sector position information stored in the memory during the data verify processing, and a judgment unit for comparing the number of sectors in which errors have occurred per prescribed recording area computed by the error sector computing unit with a prescribed reference value set in advance, and for judging whether to halt the data verify process, and that when the judgment unit judges that the data verify processing be halted, the re-execution controller halt the data verify processing, and re-execute the data write processing and data verify processing.

It is preferable that the magneto-optical disc device comprises a counter for counting the number of executions of the data write processing and data verify processing, and a reference value modification unit for increasing the prescribed reference value when the number of executions of the data write processing and data verify processing as counted by the counter exceeds a prescribed threshold value set in advance.

It is preferable that the magneto-optical disc device comprise a consecutive error sector computing unit for computing the number of consecutive sectors in which errors have occurred, based on the sector position information stored in the memory during data verify processing, and a data verify re-processing unit for re-performing the data verify processing anew when the number of sectors computed by the consecutive error sector computing unit exceeds a prescribed threshold value.

It is preferable that the magneto-optical disc device comprise a recording area modification unit for causing data written to all sectors, including sectors stored in the memory in which errors have been detected, to be recorded in sectors in a storage area different from the above specified storage area, when an error is detected in data verify processing after data write processing which has been re-executed by the re-execution controller a prescribed number of times set in advance.

It is preferable that the magneto-optical disc device comprise a distance computation unit for computing the distances between sectors in which errors have occurred based on the position information for sectors in which errors have occurred stored in the memory, during the data write processing and data verify processing re-executed by the re-execution controller, and a head portion movement controller for causing movement of the head portion from a first sector in which an error has occurred to the following second sector in which an error has occurred, when the distance computed by the distance computation unit is equal to or less than a reference value set in advance, by causing scanning over recording areas formed in concentric circular shapes or spiral shapes on the magneto-optical disc, and for directly positioning the head portion at the position of the second sector when the distance computed by the distance computation unit exceeds a reference value set in advance.

It is preferable that recording areas be formed on the magneto-optical disc such that the distances between sectors are different for each zone formed in the disc radial direction, and that the reference value for judging distances between sectors be set to different values for each zone.

A method of writing data to a magneto-optical disc provided in a second aspect of the invention is a method of writing data to a magneto-optical disc, comprising a data writing step of scanning a head portion for reading data from and writing data to a magneto-optical disc over recording areas comprising a plurality of specified sectors on the magneto-optical disc and performing processing to write the data; a data verify step of performing data verify processing to verify, for each sector, the correctness of data written to the recording area; and a re-execution step, when an error is detected in the data verify step, of modifying the output conditions of the head portion and re-executing the data write processing and the data verify processing. According to the present invention, all sectors in which errors have occurred are detected in the data verify step, position information of these sectors on the magneto-optical disc is stored in a memory, and re-execution of the data write processing and data verify processing is performed only for those sectors in which errors have occurred which are stored in the memory.

It is preferable that the above data write method comprise a counting step of counting the number of sectors in which errors have occurred, based on the sector position information stored in the memory during the data verify processing; a judgment step of comparing the cumulative value of the number of sectors in which errors have occurred, counted in the counting step, with a prescribed reference value set in advance, and of judging whether to halt the data verify processing; and, a step, when it is judged that the data verify processing be halted in the judgment step, of halting the data verify processing, in order to re-execute the data write processing and data verify processing.

It is preferable that the above data write method comprise a computation step of computing the number of sectors in which errors have occurred per prescribed recording area comprising a plurality of sectors, based on the sector position information stored in the memory during the data verify processing, a judgment step of comparing the number of sectors in which errors have occurred per prescribed recording area computed in the error sectors computation step with a prescribed reference value set in advance, and of judging whether to halt the data verify process, and a step, when in the judgment step it is judged that the data verify processing be halted, of halting the data verify processing, in order to re-execute the data write processing and data verify processing.

It is preferable that the above data write method comprise a counting step of counting the number of executions of the data write processing and data verify processing, and a reference value modification step of increasing the prescribed reference value when the number of executions of the data write processing and data verify processing as counted in the counting step exceeds a prescribed threshold value set in advance.

It is preferable that the above data write method comprise a consecutive error sectors computation step of computing the number of consecutive sectors in which errors have occurred, based on the sector position information stored in the memory during data verify processing, and a data verify re-processing step of re-performing the data verify processing anew when the number of sectors computed in the consecutive error sectors computation step exceeds a prescribed threshold value.

It is preferable that the above data write method comprise a recording area modification step of causing data written to all sectors, including sectors stored in the memory in which errors have been detected, to be recorded in sectors in a storage area different from the above specified storage area, when an error is detected in data verify processing after data write processing which has been re-executed a prescribed number of times set in advance.

Various other characteristics and advantages of the invention will become clear through the aspects below, which are explained referring to the attached drawings.

### BRIEF DESCRIPTION OF THE DRAWINGS

FIG. 1 shows the configuration of a magneto-optical disc device of this invention;

FIG. 2 shows an example of tracks formed on a magneto-optical disc;

FIG. 3 is a flowchart showing processing to record data in a magneto-optical disc device of this invention;

FIG. 4 is a flowchart which continues that of FIG. 3;

FIG. 5 shows an example of a procedure to record data in a magneto-optical disc device of this invention;

FIG. 6 is a flowchart showing a second aspect of data recording processing in a magneto-optical disc device of this invention;

FIG. 7 is a flowchart showing a third aspect of data recording processing in a magneto-optical disc device of this invention;

FIG. 8 is a flowchart showing a fourth aspect of data recording processing in a magneto-optical disc device of this invention;

FIG. 9 is a flowchart showing a fifth aspect of data recording processing in a magneto-optical disc device of this invention;

FIG. 10 is a flowchart showing processing to improve the efficiency of positioning of an optical head on an error track in verify processing performed only for error sectors; and,

FIG. 11 shows an example of a procedure to record data in a magneto-optical disc device of the prior art.

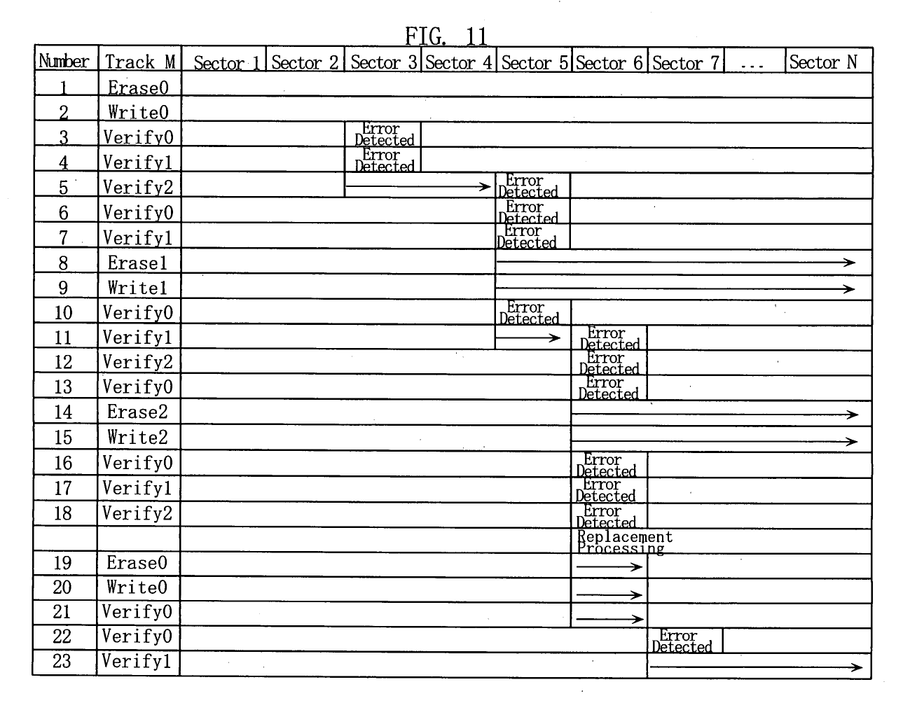

### BEST MODE FOR CARRYING OUT THE INVENTION

Preferred embodiments of the invention will now be described with reference to the drawings.

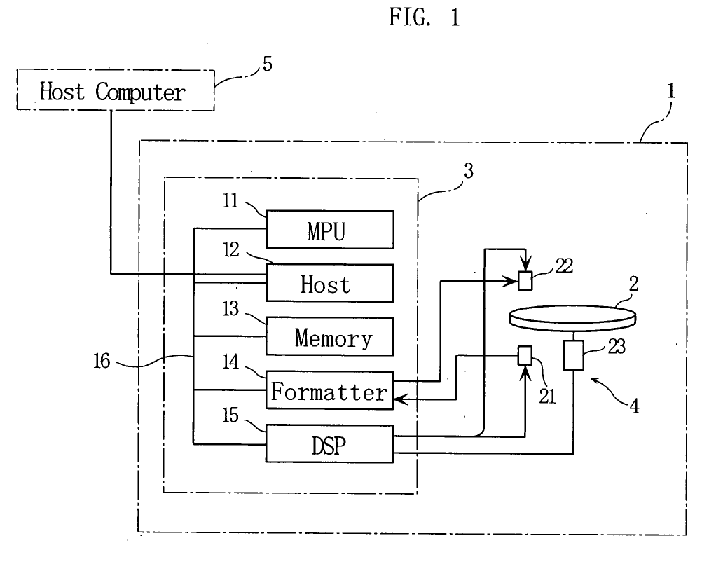

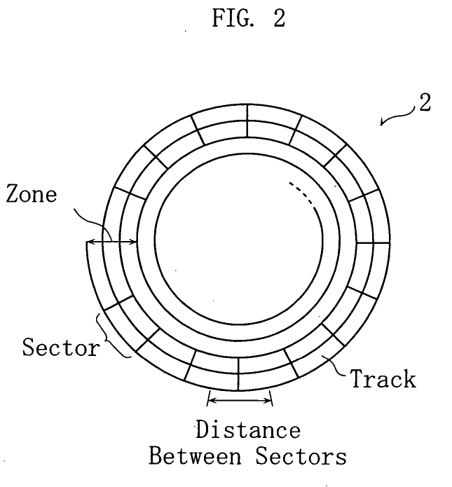

FIG. 1 an example of the configuration of a magneto-optical disc device to which this invention is applied. FIG. 2 shows an example of tracks formed on a magneto-optical disc.

This magneto-optical disc device 1 comprises a mountable magneto-optical disc 2, and is used to write data onto a magneto-optical disc 2 or to read data from a magneto-optical disc 2.

The magneto-optical disc 2 used in this aspect is formatted using the ZCAV (Zoned Constant Angular Velocity) method or the ZCLV (Zoned Constant Linear Velocity) method. Specifically, as shown in FIG. 2, by cutting a spiral-shape guide groove in advance in the surface of the magneto-optical disc 2 proper, a track (land) on which data is recorded is formed in a spiral shape; and this track is divided into a plurality of tracks in units of one disc circumference, and a track number is recorded in advance on each track. Further, the plurality of tracks formed in the radial direction of the disc is divided into a plurality of zones in the disc radial direction. Also, each track is divided into a plurality of sectors (recording area units), and a sector number is recorded in advance in each sector. In this aspect, the Mth track (where M is an integer) counting toward the center from the outermost track is called the “Mth track”.

The ZCAV method is a method of data reading and writing in which the magneto-optical disc is rotated such that the angular velocity is held constant within a zone, and the angular velocity differs for different zones. The ZCLV method is a method of data reading and writing in which the magneto-optical disc is rotated such that the linear velocity is held constant within a zone, and the linear velocity differs for different zones. Hence the distances between sectors of tracks contained within the same zone are the same, but between zones the distances between sectors differ, and the further to the outside a zone is located, the shorter are the distances between sectors. That is, the further a zone is toward the outside, the shorter are the sector lengths, and the higher are the bit recording densities in sectors.

Each sector has a preformatted header area and a data area for recording data; a sector mark, sync signal, track number, sector number, error correction codes (ECC), and similar are recorded in advance in the header area.

In data recording/reproduction processing, when the track number and sector number for recording of data from the host computer are specified, the optical head of the magneto-optical disc device 1 is moved in the radial direction of the magneto-optical disc 2 while reading track numbers and sector numbers, to move the optical head to the specified recording position (sector position). Then, data is recorded to or read from the recording area containing the specified track number and sector number on the magneto-optical disc 2, while moving the optical head along the guide groove.

As shown in FIG. 1, the magneto-optical disc device 1 comprises a disc controller 3 and disc access mechanism 4. The magneto-optical disc device 1 is connected to the host computer 5.

The disc access mechanism 4 is a mechanical portion used to cause driving of constituent components necessary for data writing to or data reading from the magneto-optical disc 2.

The disc access mechanism 4 comprises an optical head 21, which irradiates the bottom surface of the magneto-optical disc 2 with a light spot to perform data recording/reproduction; a magnetic head 22, which applies a magnetic field to the magneto-optical disc 2 for the purpose of data recording/reproduction; and a motor 23, to rotate the magneto-optical disc 2 during data recording/reproduction. The optical head 21 is provided below the magneto-optical disc 2 so as to enable motion in the radial direction of the magneto-optical disc 2; the magnetic head 22 is provided above the magneto-optical disc 2 so as to enable motion in the radial direction of the magneto-optical disc; and the motor 23 is provided below and at the center of the magneto-optical disc 2.

Though not shown in FIG. 1, the disc access mechanism 4 also comprises an actuator to move the optical head 21 and magnetic head 22 in the radial direction of the magneto-optical disc 2.

In the magneto-optical disc device 1 of this aspect also, the laser light power output from the optical head 21 can be changed in three stages for each of erase processing, write processing, and verify processing. That is, the power output level for erase processing can be set at three power output stages, which are “Erase0”, “Erase1” and “Erase2”; the power output level for write processing can be set at three power output stages, which are “Write0”, “Write1” and “Write2”; and the power output level for verify processing can be set at three power output stages, which are “Verify0”, “Verify1” and “Verify2”.

The disc controller 3 controls driving of the optical head 21, magnetic head 22 and motor 23 of the disc access mechanism 4, based on command signals transmitted from the host computer 5, and controls processing for data writing to the magneto-optical disc 2 and processing for data reading from the magneto-optical disc 2.

The disc controller 3 comprises an MPU 11, host I/F 12, memory 13, formatter 14, and DSP (Digital Signal Processor) 15. The MPU 11 is connected via the bus line 16 to the host I/F 12, formatter 14, memory 13, and DSP 15.

The MPU 11 governs the entire magneto-optical disc device 1, and outputs prescribed control signals to the formatter 14, DSP 15, host I/F and similar based on a control program stored in memory 13, to control operation of these members.

The host I/F 12 controls the transfer of data to and from the host computer 5. The host I/F 12 provides write command signals sent from the host computer 5 to the MPU 11, and transfers data for writing to a magneto-optical disc 2 to memory 13.

The memory 13 stores a control program for execution by the MPU 11, data for writing to the magneto-optical disc 2, position information for sectors on the magneto-optical disc 2 in which errors have occurred (described below), and similar.

The formatter 14 controls operations to write data to a magneto-optical disc 2 and operations to read data from a magneto-optical disc 2. The formatter 14 controls data write operations and read operations by means of the above-described optical modulation recording method. In the optical modulation recording method, when recording data onto a magneto-optical disc 2 as described above, three processing types, which are erase processing, write processing, and verify processing, are performed as a series of processing. In the explanation of data recording processing using the optical modulation recording method, the explanation was divided into three types of processing, which are erase processing, write processing, and verify processing. Erase processing is equivalent to preprocessing in order to perform data write processing; in effect, data is written by means of erase processing and write processing. In verify processing, verification of the written data is performed. Hence processing to write data in the data writing method of this invention is equivalent to processing which combined erase processing and write processing, whereas processing for data verification is equivalent to verify processing.

The formatter 14 controls data write operations, read operations, and data verification operations, in the series of erase processing, write processing and verify processing during processing to record data on a magneto-optical disc 2.

As explained above, in a magneto-optical disc device of the prior art, when an error is detected in verify processing (including retries), at that time the verify processing is interrupted, the laser light power output is switched, and verify processing is again performed from the sector in which the error occurred; but in the magneto-optical disc device 1 of this aspect, even when an error is detected in initial verify processing, the formatter 14 does not interrupt verify processing, but stores position information for the sector in which the error occurred in memory 13, and continues verify processing until the end of the sectors specified as the recording area. That is, in verify processing within the magneto-optical disc device 1 of this aspect, the initial verify processing is processing to detect the positions of sectors in which errors occur over the whole range of sectors specified as the recording area, and to record the sector positions in memory 13.

When verify processing up to the last specified sector ends, the formatter 14 next switches the laser light power output, and executes verify processing anew, only for sectors in which errors have occurred. This re-execution of verify processing is processing to verify whether errors occur once again in sectors in which errors have been detected. Hence in re-executing verify processing, the verify processing is not interrupted even when an error is again detected, and verification of error re-occurrence is performed for all sectors in which an error had occurred.

The DSP 15 controls the disc access mechanism 4 according to control signals from the formatter 14. That is, the DSP 15 rotates the motor 23, and moves the optical head 21 and magnetic head 22 to the target track, according to control signals from the formatter 14. The DSP 15 also controls the laser light power output conditions of the optical head 21 and the magnetic field generation conditions of the magnetic head 22 and similar during erase processing, write processing and verify processing, based on control signals from the formatter 14.

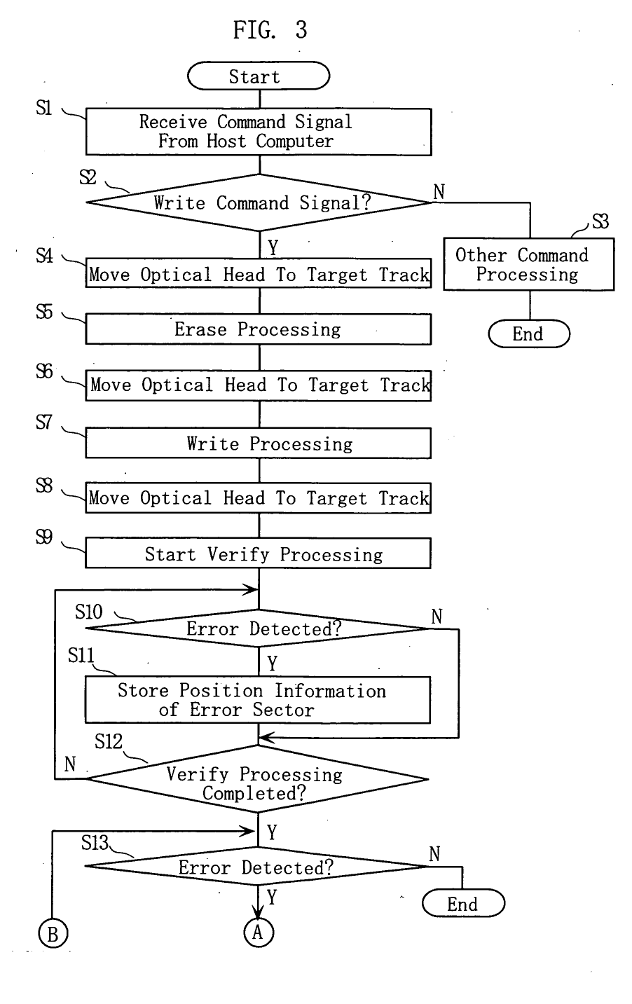

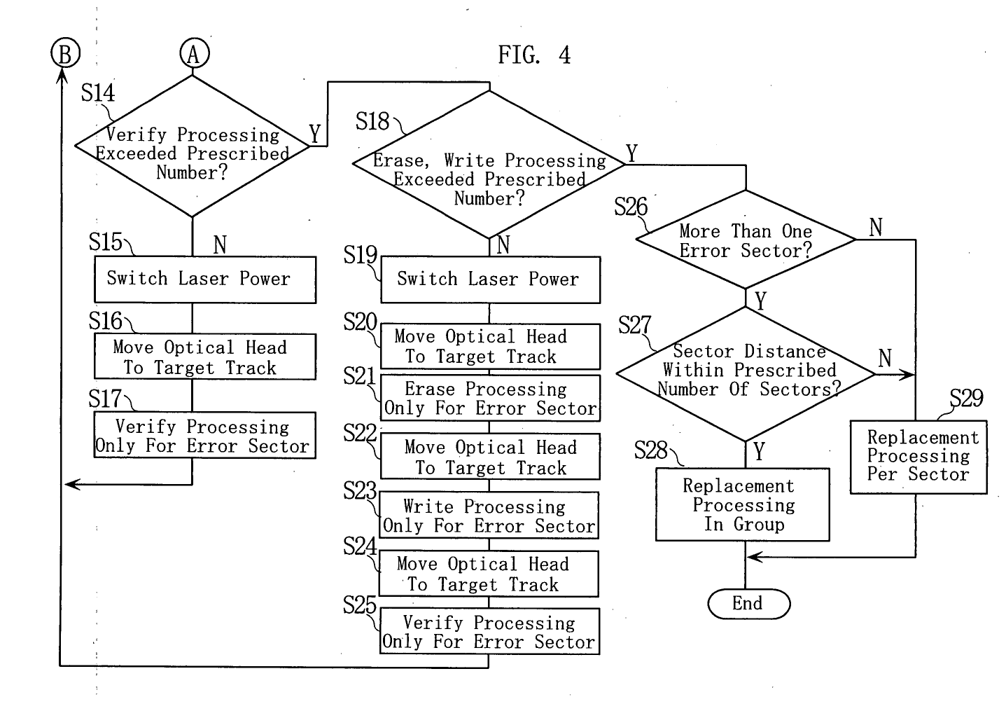

Next, data recording processing in a magneto-optical disc device 1 is explained. FIG. 3 and FIG. 4 are flowcharts showing operations in the magneto-optical disc device 1.

When a magneto-optical disc 2 is loaded into the magneto-optical disc device 1, a command signal is sent from the host computer 5 to the disc controller 3. The I/F 12 of the disc controller 3 receives the command signal (S1), and notifies the MPU 11.

The MPU 11 analyzes the command signal received by the host I/F 12. Specifically, the MPU 11 judges whether the command signal is a write command signal (S2), and if the command signal is not a write command signal (S2: NO), performs processing for another command signal (S3).

If the MPU 11 judges the command signal to be a write command signal (S2: YES), the MPU 11 issues an instruction to the formatter 14 to perform the processing corresponding to the write command signal (data recording processing), and stores in memory 13 the write data sent from the host computer 5 via the host I/F 12 following the write command signal. Upon receiving the instruction for data recording processing from the MPU 11, the formatter 14 reads the information in the data write area (track number and sector number information) contained in the write command signal, transfers this information to the DSP 15, and causes the DSP 15 to move the optical head 21 and magnetic head 22 to the target track on the magneto-optical disc 2.

The entirety of the optical head 21 and magnetic head 22 are made able to move in the radial direction of the magneto-optical disc 2. Further, the optical head 21 is equipped with an objective lens (not shown), movable in the radial direction of the magneto-optical disc 2, which focuses laser light on the surface of the magneto-optical disc 2 to form a light spot in order to write data to or read data from the magneto-optical disc 2. Seek control of the optical head 2 is performed by means of coarse movement control to move the entire optical head to the vicinity of the target track, and tracking control to move only the objective lens slightly such that the light spot onto the target track.

Upon receiving data write area information from the formatter 14, the DSP 15 starts the motor 23 and causes the magneto-optical disc to be rotated, and acquires current track position information by reading the track number from the magneto-optical disc 2 using the optical head 21. Then the DSP 15 computes the movement distance for the optical head 21, based on the current track position information and position information for the target track sent from the formatter 14, and based on the computation result moves the entire optical head 21 and magnetic head 22 in the radial direction of the magneto-optical disc 2 to the vicinity of the target track (for example, track M).

A position detection device (for example, a linear encoder or similar) which detects the position for each track position on a magneto-optical disc is provided in the actuator which moves the entire head; the DSP 15 moves the entire head to the vicinity of the target track based on the information detected by this position detection device. Then, the DSP 15 uses the optical head 21 to read the track number information from the magneto-optical disc 2, and based on this information moves the objective lens a minute amount to position the light spot on the target track (S4).

Next, the formatter 14 begins an operation to write data to the magneto-optical disc 2 via the DSP 15. If the recording area containing the information of the area for data writing extends from sector 1 to sector N (where N is an integer) of the Mth track, then the formatter 14 first performs processing to erase sector 1 to sector N of track M, via the DSP 15 (S5). That is, the DSP 15 applies an upward-directed magnetic field from the magnetic head 22 to the magneto-optical disc 2, and irradiates the magneto-optical disc 2 with laser light at prescribed high power from the optical head 21 to erase the data from sector 1 to sector N of track M.

When the erase processing is completed, the DSP 15 again moves the optical head 21 and magnetic head 22 to the target track (S6). Then, the formatter 14 performs processing to write data, via the DSP 15, to sector 1 to sector N of track M (S7). That is, the DSP 15 applies a downward-directed magnetic field from the magnetic head 22 to the magneto-optical disc 2, and by irradiating the magneto-optical disc 2 with prescribed high-power laser light from the optical head 21 based on data bit information sent from the host computer 5, writes data to sector 1 to sector N of track M.

When write processing is completed, the DSP 15 again moves the optical head 21 and magnetic head 22 to the target track (S8). Then the formatter 14 begins verify processing, in which the data written to the magneto-optical disc 2 is read from each sector and is compared with the data sent from the host computer 5 and stored in memory 13 (S9).

That is, the formatter 14 judges whether the data read from each sector (hereafter called “readout data”) matches the corresponding sector data stored in memory 13 (hereafter called “original data”) (S10), and if the readout data and the original data do not match (S10: YES), judges that an error has occurred, and stores the sector number (equivalent to the sector position information) in memory 13 (S11).

Then, the formatter 14 judges whether the verify processing has been completed up to the last sector, which is sector N (S12). If it is judged that verify processing has not been completed up to the last sector N (S12: NO), processing returns to step S10, and verify processing is performed for the next sector (S10, S11). Subsequently, similar verify processing is performed for each sector (looping through S10 to S12), and when verify processing is completed for all sectors from sector 1 to sector N (S12: YES), the formatter 14 then references memory 13 and judges whether there exist sectors for which errors have been detected in the verify processing (hereafter called “error sectors”)(S13).

If the formatter 14 judges that there are no error sectors (S13: NO), the write operation ends. If on the other hand the formatter 14 judges that there exist sectors in which errors were detected (S13: YES), a judgment is made as to whether the number of verify processing executions has exceeded a prescribed number of times (for example, three times) (S14 in FIG. 4).

If the formatter 14 judges that the number of verify processing executions has not exceeded the prescribed number of times (S14: NO), the formatter 14, via the DSP 15, switches the laser light output power of the optical head 21 in verify processing (S15), and moves the optical head 21 and magnetic head 22 to the target track (S16). Then, the formatter 14 performs verify processing for sectors of the track in which errors have occurred (S17).

That is, via the DSP 15, the formatter 14 moves the optical head 21 along the target track, and upon reaching the position of an error sector, reads the data from the error sector and compares the data with the original data stored in memory 13. If the data matches, the position information for the error sector stored in memory 13 is erased. If the data does not match, the error sector position information stored in memory 13 is not erased. The formatter 14 performs verify processing similar to that described above each time the optical head 21 moves to the position of an error sector, and when verify processing is completed for all error sectors, processing returns to step S13. In this verify processing, the formatter 14 moves the optical head 21 without performing verify processing in sector portions which are not error sectors. That is, the formatter 14 scans the optical head 21 idly over the track from one error sector to the next error sector.

On the other hand, when the formatter 14 judges that the number of verify processing executions has exceeded a prescribed number of times (for example, three times) (S14: YES), in other words, when errors occur even when the laser light power output is switched and verify processing is performed the prescribed number of times, the laser light power output is switched, and erase processing and write processing are performed. The erase processing and write processing at this time are also performed only for sectors in which errors have occurred.

Specifically, the formatter 14 judges whether the number of executions of verify processing and write processing has exceeded a prescribed number of times (for example, three times) (S18). If it is judged that the number of executions of erase processing and write processing has not exceeded the prescribed number of times (S18: NO), the formatter 14, via the DSP 15, switches the laser light power output in erase processing (S19) and moves the optical head 21 and magnetic head 22 to the target track (S20). The formatter 14 then performs erase processing only for error sectors contained in the target track (S21). The method of movement of the optical head 21 to sectors in this erase processing is similar to that in the verify processing of step S17.

When erase processing ends, the formatter 14, via the DSP 15, switches the laser light power output for write processing, and moves the optical head 21 and magnetic head 22 to the target track (S22).

Next, the formatter 14 performs write processing only in sectors in which errors have occurred and erase processing has been performed (S23). The method of movement to sectors of the optical head 21 in this write processing is similar to that in the verify processing of step S17. When write processing ends, the formatter 14, via the DSP 15, switches the laser light power output for verify processing, and moves the optical head 21 and magnetic head 22 to the target track (S24). Then, verify processing is performed only for those sectors in which erase processing and write processing had been performed immediately beforehand (S25), and processing returns to the judgment processing of step S10 to judge whether an error has been detected. The verify processing of step S25 is similar to the verify processing in step S17.

On the other hand, if in step S18 the number of executions of erase processing and write processing is judged to have exceeded a prescribed number of times (for example, three times) (S18: YES), sector replacement processing is performed (S26 to S29). In this case, when the number of error sectors stored in memory 13 is greater than one, replacement processing is performed for all error sectors in a group, and if the number of error sectors stored in memory 13 is one, replacement processing for that error sector is performed.

That is, the formatter 14 judges whether the number of stored error sectors is greater than one (S26). When it is judged that the number of error sectors is greater than one (S26: YES), the formatter 14 judges whether the distance between one error sector and the next error sector is within the distance between a prescribed number of sectors, determined in advance (S27). Specifically, when there exists a sector in which no errors have occurred between adjacent error sectors, the formatter 14 judges whether the number of [intervening] sectors is within a prescribed number of sectors determined in advance (S27). When it is judged that the number of sectors existing between one error sector and the next error sector is within the prescribed number of sectors determined in advance (S27: YES), the formatter 14 performs replacement processing in a group for the plurality of sectors (S28). For example, when the three sectors 6, 8 and 10 are stored in memory 13 as error sectors, if in verify processing it is judged that replacement processing must be performed for sector 6, then replacement processing is performed for sectors 8 and 10, for which verify processing has not yet ended, together with sector 6.

On the other hand, if in step S26 the number of error sectors is only one (S26: NO), or if in step S27 the number of sectors existing between an error sector and the next error sector exceeds the prescribed number of sectors set in advance (S27: NO), then replacement processing is performed for each of the error sectors individually (S29).

The reason for performing replacement processing in a group for data in error sectors when the distance between adjacent error sectors is within the distance of a prescribed number of sectors, as explained above, is as follows. Because replacement processing is processing to record the data for an error sector in another sector, when replacement processing is performed an operation is required to move the optical head 21 and magnetic head 22 to another sector position. If replacement processing is performed for each error sector, the optical head 21 and magnetic head 22 must be positioned at a different sector position each time, so that time is required for this positioning processing; hence when there are a plurality of error sectors, and moreover the error sectors exist within a prescribed distance, by performing sector replacement processing in a group even when there are error sectors for which verify processing has not yet been completed, the time required for processing to position the optical head 21 and magnetic head 22 in replacement processing can be shortened.

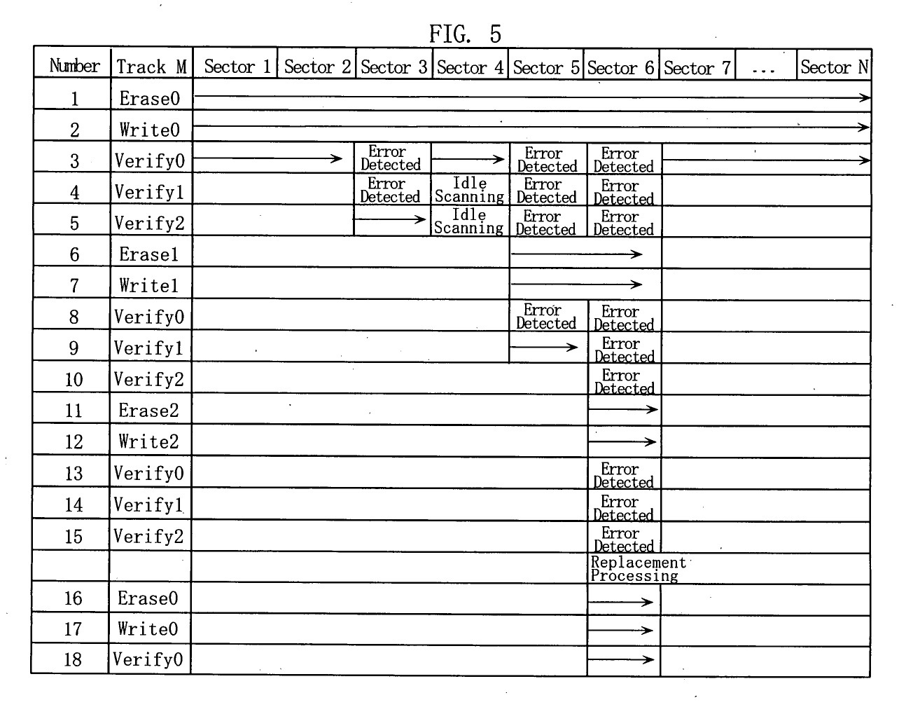

Next, the example of FIG. 5 is used to explain in detail the procedure of operation of the magneto-optical disc device 1 when an error occurs during verify processing.

In FIG. 5, “number” refers to the number of times the magneto-optical disc has been accessed, “Erase0” to “Erase2” indicate laser light power output levels in erase processing, “Write0” to “Write2” indicate laser light power output levels in write processing, and “Verify0” to “Verify2” indicate laser light power output levels in verify processing.

According to the figure, after execution of erase processing using the “Erase0” power output condition and write processing using the “Write0” power output condition, an error is detected in sector 3 during verify processing using the “Verify0” power output condition. At this time the verify processing is not interrupted, but position information for sector 3 is stored in memory 13. Then, verify processing is continued from the following sector 4, position information for sector 5 and sector 6, in which errors have occurred, is stored in memory 13, and the verify processing is executed up to the last sector, which is sector N.

When verify processing using the “Verify0” power output condition is completed, verify processing is executed, using the “Verify1” power output condition, for sectors in which errors have occurred. At this time, verify processing using the “Verify1” power output condition is executed only for those sectors in which errors occurred during verify processing using the “Verify0” power output condition (that is, sectors 3, 5, and 6). During the “number 4” verify processing, “idle scanning” over sector 4 indicates that, because no errors occurred in sector 4, the optical head 21 is moved to sector 5 without any verify processing.

In verify processing using the “Verify1” power output condition, errors are again detected in all of the sectors 3, and 6, and so the laser light power output condition is changed to “Verify2”, and verify processing is again performed for these sectors.

In verify processing using the “Verify2” power output condition, no error is detected in sector 3, but errors are again detected in sectors 5 and 6, and moreover the number of verify processing executions has reached the prescribed three times; hence when an error is detected in sector 6, there is a transition to data write processing for sector 5 and sector 6 (see the “number 6” and “number 7” erase processing and write processing).

In the first data write processing, after performing erase processing of sector 5 and sector 6 using the “Erase1” power output condition, the “Write1” power output condition is used to perform data write processing. Then, verify processing of sector 5 and sector 6 is performed using the “Verify0” power output condition (see the “number 8” verify processing).

In the example of FIG. 5, during verify processing using the “Verify0” power output condition, errors were detected in sector 5 and sector 6, and so the laser light power output condition is changed to “Verify1”, and verify processing is again performed; but in verify processing using the “Verify1” power output condition also, an error is detected in sector 6, and so the laser light power output condition is changed to “Verify2”, and verify processing is again performed (see the “number 9” and “number 10” verify processing).

An error is once again detected in sector 6, even in the third verify processing using the “Verify2” power output condition, and so when the error is detected in sector 6, a transition is made to processing to again write data to sector 6 (see the erase processing and write processing of “number 11” and “number 12”).

Then, a method similar to that described above is used to perform verify processing for sector 6; if, even after switching the laser light power output condition through three stages, an error is detected in sector 6, it is assumed that there is a defect in the sector on the magneto-optical disc 2 itself, and another, unused sector on the magneto-optical disc 2 is used in place of sector 6. That is, sector 6 is replaced with another sector as the data storage area, the data for sector 6 is written to this sector instead, and verify processing is performed for this other sector. (See the erase processing and write processing for “number 16” through “number 18”.)

In the example of FIG. 5, the number of error sectors when replacement processing occurs is one; but if an error sector were to exist beyond sector 6, sector replacement processing in a group would be performed for these error sectors. For example, of sector 7 were also an error sector, sector replacement processing would be performed for sectors 6 and 7.

Thus in this aspect (hereafter called the “first aspect”), when an error occurs during verify processing, position information for the sector in which the error has occurred is stored without interrupting the verify processing, and the verify processing continues to be executed. When verify processing up to the final specified sector is completed, the laser light power output is switched, and verify processing is executed once again for only those sectors in which errors have occurred.

In a magneto-optical disc device of the prior art, when an error occurs during verify processing the verify processing is interrupted, the laser light power output is switched, and verify processing is executed once again, from the sector in which the error has occurred and continuing through all subsequent sectors. Consequently each time an error occurs, the verify processing is interrupted and the optical head 21 is again moved to the sector in which the error has occurred, so that time is required for the head movement. Hence there is the problem that more time is required for the entire data writing operation. However, according to the first aspect the verify processing is continued without interruption even when an error occurs, and when verify processing is again performed the processing is executed only for those sectors in which errors have occurred, so that the processing time can be shortened and efficiency can be improved.

Further, when the laser light power output is switched and erase and write processing are performed as well, the above erase processing and write processing are performed for sectors in which errors have occurred also (see the erase processing and write processing of “number 6”, “number 7”, “number 11” and “number 12” in FIG. 5), so that erase and write processing are no longer performed for sectors not requiring erase and write processing, and for this reason also, the processing time can be shortened.

When a plurality of error sectors exist during replacement processing, replacement processing is performed in a group for the plurality of error sectors, so that the time required for processing to position the optical head 21 and magnetic head 22 in replacement processing can be reduced, and as a result the time required for recording processing overall can be reduced.

In the data recording processing of the first aspect, regardless of the number of error sectors detected during verify processing, after verify processing retry has been repeated the prescribed number of times, erase and write processing are retried.

However, when the number of error sectors detected in verify processing is large, there is the possibility that the power output conditions of the data erase processing and write processing performed immediately before are inappropriate. In such a case, there is a strong possibility that verify processing retries will be repeated the prescribed number of times also; hence when the cause of the anomalously large number of error sectors is an inappropriate power output condition for erase processing or write processing, verify processing retries will be repeated unnecessarily.

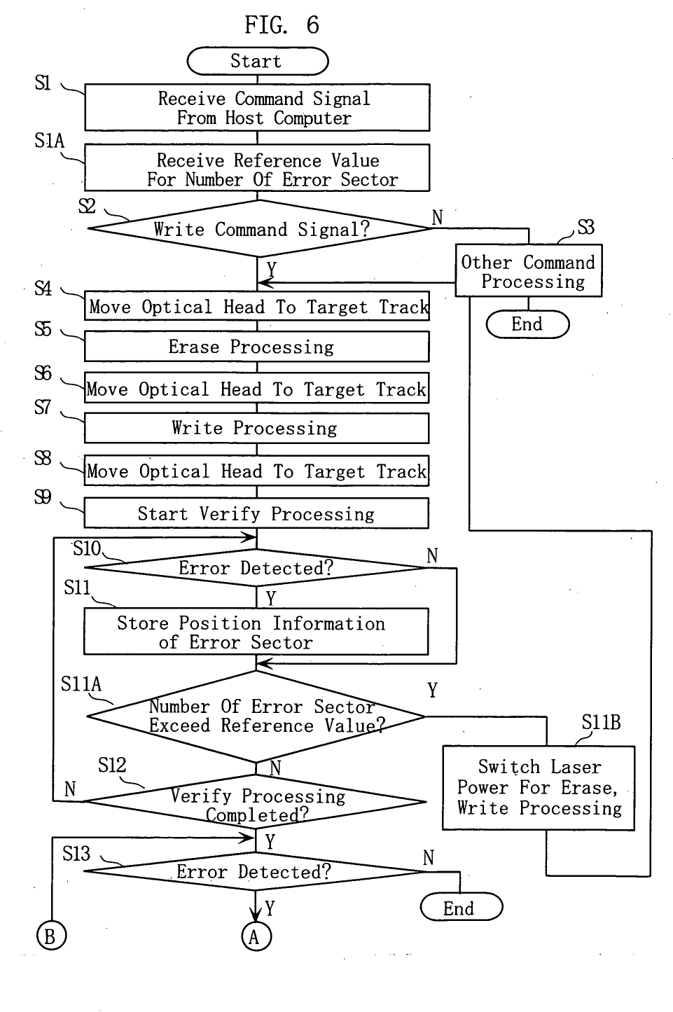

FIG. 6 is a flowchart showing a modified example of data recording processing of the above-described first aspect, intended to mitigate the above problem. FIG. 6 is equivalent to FIG. 3 and to the portion of the flowchart in FIG. 4 which is FIG. 3. The content of processing in the portion equivalent to FIG. 4 is the same as in FIG. 4, and so is omitted. That is, the flowchart of FIG. 6 succeeds the flowchart shown in FIG. 4.

In this modified example (hereafter called the “second aspect”), when the host computer 5 transmits a data write command to the magneto-optical disc device 1, a reference value for the number of sectors in which errors occur during verify processing is transmitted, and when during verify processing as part of data recording processing in the magneto-optical disc device 1 the number of sectors in which errors have occurred (hereafter called the “number of error sectors”) exceeds the reference value, it is inferred that the laser light power output during the erase processing and write processing performed immediately beforehand is erroneous; at this time the laser light power output is switched and erase and write processing are performed, that is, there is a transition to data rewrite processing.

The flowchart shown in FIG. 6 is the result of modifying FIG. 3 by inserting step S1A (processing to receive the reference value for the number of error sectors from the host computer 5 and store the value in memory 13) between step S1 and step S2, by inserting step S11A (processing to judge whether the number of error sectors detected in the initial verify processing exceeds the reference value) between step S11 and step S12, and by adding step S11B (processing to change the laser light power output conditions for erase processing and write processing) to the path returning from step S11A to step S4.

Modifications in the flowchart of FIG. 6 are explained below. After receiving a command signal from the host computer 5 in step S1 (S1), the MPU 11 receives the reference value for the number of error sectors, which is the counted number of error sectors (S1A), and stores the reference value in memory 13.

Then, in verify processing following the data write processing, after processing to store position information for sectors in which errors have occurred (S11), the formatter 14 performs processing to judge whether the number of error sectors exceeds the reference value (S11A). Specifically, the formatter 14 computes the error sectors from the error sector position information stored in memory 13, and compares the number of error sectors with the reference value for the number of error sectors sent from the host computer 5 and stored in memory 13.

If the counted number of error sectors does not exceed the reference value (S11A: NO), then processing advances to the above-described step S12; if the number of error sectors is greater than the reference value (S12A: YES), then the power output conditions for erase processing and write processing are immediately switched (S11B), processing returns to step S4, and data rewriting is performed. That is, when the number of error sectors exceeds the reference value, it is inferred that the laser light power output in the erase processing and write processing performed in steps S4 to S7 in FIG. 6 is erroneous, the laser light power output for erase and write processing is immediately switched (S11B), processing returns to step S4, and data erase processing and write processing are performed again.

In the recording processing of the first aspect, verify processing with the power output modified is performed three times regardless of the number of sectors in which errors occur during verify processing, and when there exist sectors in which errors still occur, the power output condition is modified and data rewrite processing is performed. However, in the second aspect, when the number of error sectors exceeds the reference value set by the host computer 5, even in the initial verify processing, it is assumed that data write processing was performed at an erroneous laser light power output, the power output condition is changed immediately, and data rewrite processing is performed. Hence unnecessary verify processing performed after erase and write processing can be eliminated, and as a result the overall processing time for data recording can be shortened.

In the second aspect, the reference value set by the host computer 5 is used to judge whether the laser light power output is erroneous during data write processing; this is because it is thought that the number of sectors required differs according to the amount of data to be recorded, and the reference value should be in accordance with the number of sectors.

Because the number of sectors of each track is substantially the same, the number of error sectors per track may be computed from the total number of error sectors obtained in verify processing, and by comparing the number of error sectors per track with a prescribed reference value (threshold value), a judgment may be made as to whether data write processing was performed at an erroneous laser light power output.

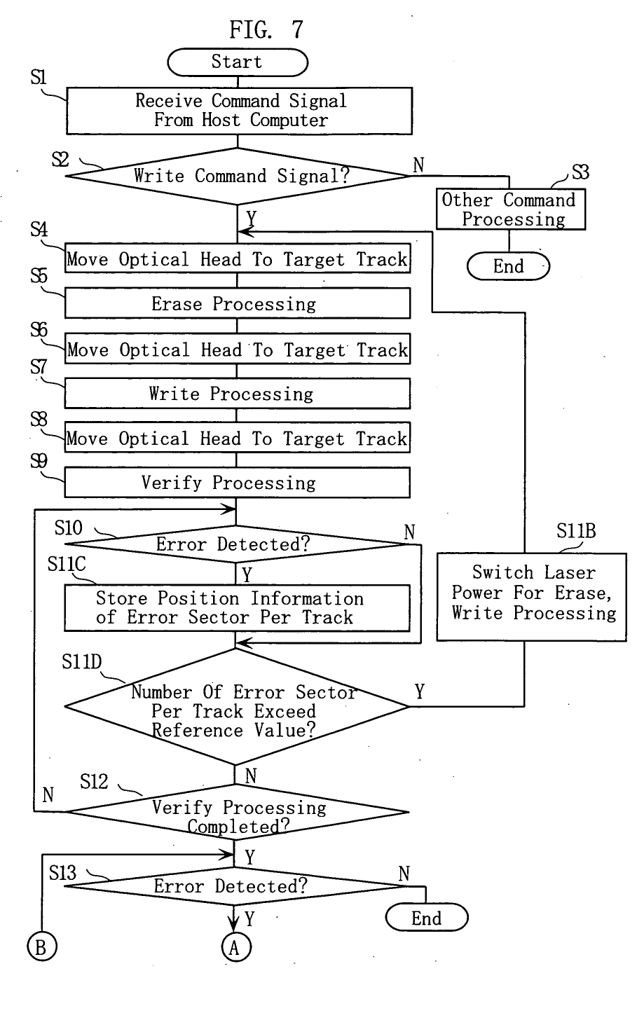

The flowchart shown in FIG. 7 shows the procedure of processing when using the number of error sectors per track, and is obtained from the flowchart shown in FIG. 6 by deleting step S1A, changing the processing of step S11 and step S11A to the processing of step S11C and step S11D, and inserting the processing of step S11B in the return path from step S11D to step S4. The processing of step S11C is processing to compute the number of error sectors per track from position information for error sectors stored in memory 13, and processing to judge whether the number of error sectors per track computed in step S11C is equal to or greater than the prescribed reference value (threshold value) stored in memory 13. In FIG. 7, the reference value (threshold value) per track is set in advance in the magneto-optical disc device 1, and so processing equivalent to that of step S1A is not provided.

Modifications in the flowchart of FIG. 7 are explained below. After detecting an error (S10) in verify processing following data write processing, the formatter 14 computes the number of error sectors from error sector position information stored in memory 13, computes the number of tracks from the track numbers for recording of data specified by the host computer 5, and by dividing the number of error sectors by the number of tracks, calculates the number of error sectors per track (S11C).

Then, the formatter 14 performs processing to judge whether the computed number of error sectors per track is greater than a prescribed reference value stored in memory 13 (S11D). If the computed number of error sectors per track does not exceed the prescribed reference value (S11D: NO), processing advances to the above-described step S12, but if the number of error sectors per track exceeds the prescribed reference value (S11D: YES), the laser light power output in erase processing and write processing is immediately switched (S11B), processing returns to step S4, and data erase processing and write processing are again performed. That is, when the number of error sectors exceeds a reference value, it is inferred that the laser light power output during the erase processing and write processing in steps S4 to S7 of FIG. 7 is erroneous, the laser light power output for erase processing and write processing is immediately switched, and data erase processing and write processing are again performed.

In this method (hereafter the recording processing of this method is called the “third aspect”), there are the advantages that there is no need for the host computer 5 to set a reference value according to the amount of data for recording, and if a reference value for the number of error sectors per track is set or recorded in advance in the magneto-optical disc device 1, then when a magneto-optical disc 2 is loaded into the magneto-optical disc device 1, the reference value can be read and set in the magneto-optical disc device 1. In this third aspect, advantageous results similar to those of the above-described second aspect are also obtained.

However, in the above-described third aspect, if the number of error sectors per track in verify processing exceeds a prescribed reference value set in advance, there is a transition in which the laser light power output in erase processing and write processing at that time is switched and data write processing is again performed; but when the number of error sectors per track detected in the verify processing following this data writing exceeds the prescribed reference value, it may be considered that damage to the recording area on the magneto-optical disc 2 has occurred, rather than a problem with the data writing conditions, and that there is an increased possibility of a transition to error sector replacement processing after repeating the above-described data write processing and verify processing the prescribed number of times. Thus the erase processing, write processing and verify processing are repeated any number of times, so that more time is required for recording processing.

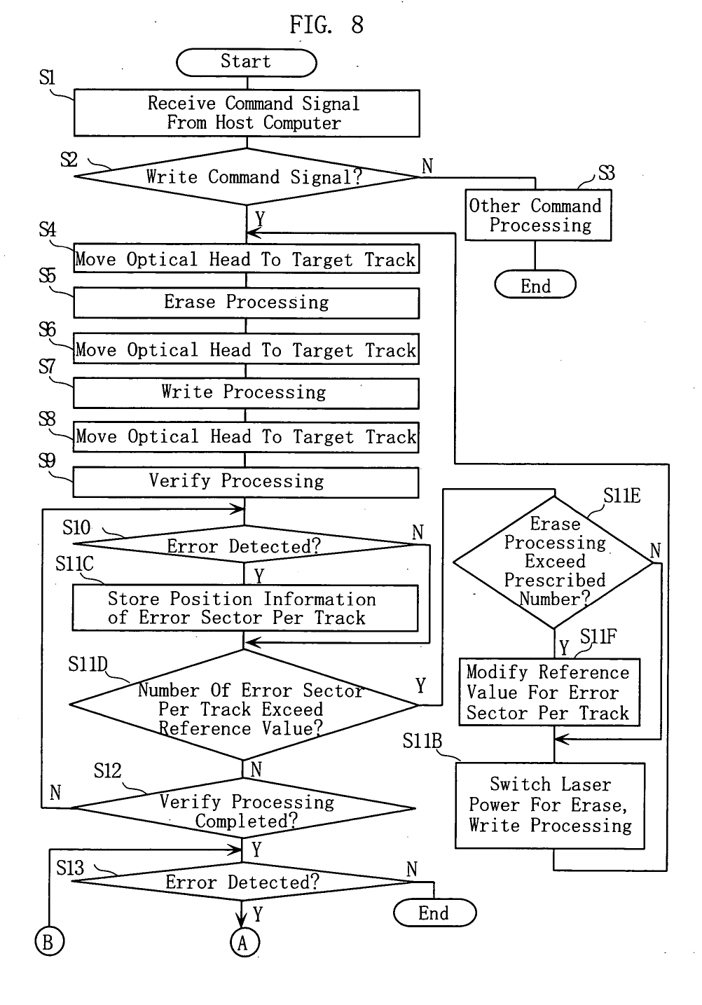

FIG. 8 is a flowchart showing a modified example of data recording processing in the above third aspect in order to mitigate the above problem. FIG. 8 corresponds to the flowchart shown in FIG. 7, and so in this modified example also the portion equivalent to FIG. 4 is omitted.

In this modified example (hereafter called the “fourth aspect”), when the number of error sectors per track, detected in verify processing after the laser light power output is switched and erase and write processing have been performed, exceeds the prescribed reference value, it is inferred that the cause of the errors is not the laser light power output during erase processing and write processing, but damage occurring on the magneto-optical disc 2, and so the reference value is increased, that is, the judgment threshold value for the number of error sectors per track during verify processing is relaxed, and the number of retries in subsequent verify processing is reduced.

The flowchart shown in FIG. 8 is obtained from the flowchart of FIG. 7 by adding, to the path of transition to step S11B when there is a YES judgment in step S11D, the processing of step S11E (processing to judge whether erase processing has been performed a prescribed number of times) and the processing of step S11F (processing to increase the reference value for the number of error sectors per track).

Modifications in the flowchart of FIG. 8 are explained below. Upon judging in step S11D that the number of error sectors per track is greater than the prescribed reference value (S11D: YES), a judgment is made as to whether erase processing has been performed a prescribed number of times (for example, two times) (S11E), and if the erase processing has been performed the prescribed number of times (S11E: YES), the reference value for the number of error sectors per track is increased (S11F). Then the laser light power output in erase and write processing is switched (S11B), processing returns to step S4, and data erase and write processing are again performed.

As explained above, in the fourth aspect, when the number of error sectors exceeds the reference value even when erase and write processing are performed the prescribed number of times with the laser light power output switched, it is judged that the cause of the occurrence of errors is not an incorrect laser light power output in erase and write processing, but damage on the magneto-optical disc 2, and so the reference value for the number of error sectors per track is increased. Hence errors due to damage are not effectively counted as a number of error sectors, and so unnecessary verify processing after erase and write processing performed with the laser light power output switched can be reduced.

The example of the flowchart shown in FIG. 8 is used to explain an improved example of the third aspect; but a similar advantageous result can be obtained by applying to the second aspect the method of increasing the reference value and relaxing the judgment threshold value for the number of error sectors, to reduce the number of retries in subsequent verify processing. That is, in the flowchart shown in FIG. 6, to the path of the transition to step S11B upon a YES judgment in step S11A may be added the processing of step S11E (processing to judge whether erase processing has been performed the prescribed number of times) and processing equivalent to that of step S11F (processing to increase the reference value for the number of error sectors).

However, in processing to record data onto the magneto-optical disc 2, when there is a shift in the reading of sector position information by the optical head 21, due for example to an external shock or other cause, there is a shift from the sectors corresponding to the original data, and so in verify processing of subsequent sectors, errors will be detected in all [sectors]. In this case, numerous sectors are detected as error sectors in the initial verify processing, and the positions of the error sectors are consecutive.

In the case of such an anomaly in recording processing, in the above-described second through fourth aspects it is judged that the initial power output conditions of data erase and write processing are inappropriate, and the subsequent processing is performed accordingly; but this cannot be said to be processing appropriate to the occurrence of numerous error sectors arising from an operation anomaly of the disc access mechanism 4 such as a shift in the position of the optical head 21, and unnecessary verify processing retries and data erase and write processing retries are performed, detracting from the rapidity of data recording processing.

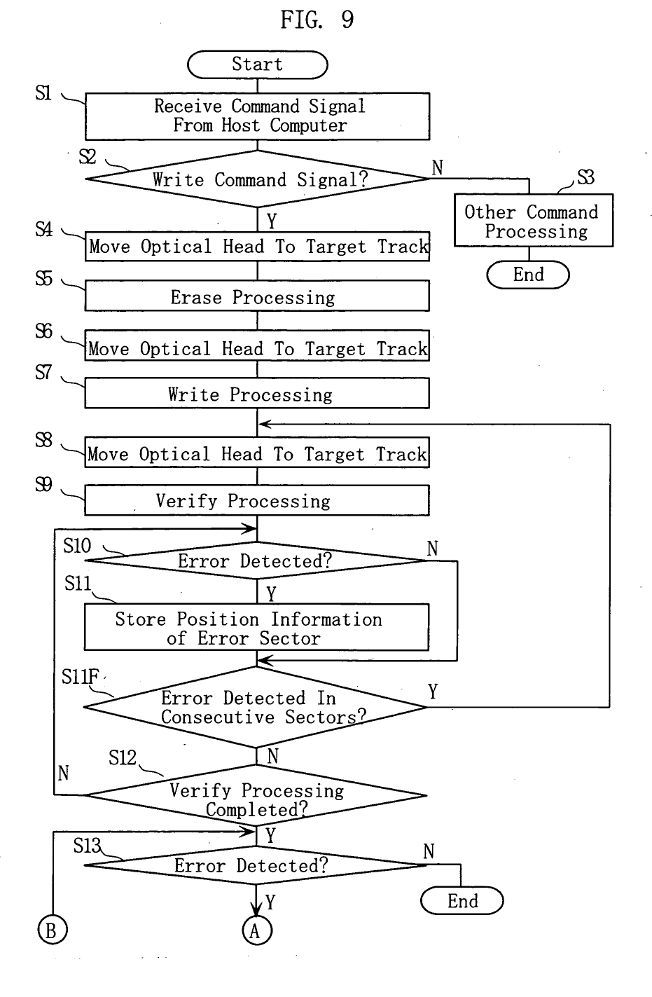

The flowchart shown in FIG. 9 is a flowchart showing a modified example of the data recording processing of the above first aspect, to mitigate the above problem. FIG. 9 corresponds to the flowchart of FIG. 3, and in this modified example also the portion equivalent to FIG. 4 is omitted.

In this modified example (hereafter called the “fifth aspect”), when for example errors occur in consecutive sectors during verify processing, it is inferred that the cause is a shift in the position of the optical head 21 or some other anomalous operation of the disc access mechanism 4, the verify processing is interrupted immediately, and verify processing is re-executed anew.

In the fifth aspect, because there is no reason to continue verify processing when numerous sectors arising from a shift in the position of the optical head 21 or a similar cause are consecutive error sectors, verify processing is immediately interrupted, verify processing is re-executed anew at the same laser light power output, and prolonging of the recording processing due to unnecessary verify processing is prevented.

Hence the flowchart of FIG. 9 is obtained from the flowchart of FIG. 3 by adding the processing of step S11F (processing to judge whether errors have occurred in a prescribed number of consecutive sectors) between step S11 and step S12.

Modifications in the flowchart of FIG. 9 are explained below. After storing error sector position information in memory 13 (S11), the formatter 14 judges whether errors have occurred in consecutive sectors and the number of the error sectors exceeds a prescribed number (S11F); if the sectors in which errors have occurred are judged not to be consecutive (S11F: NO), processing advances to judgment of whether verify processing has been completed (S12).

If on the other hand the formatter 14 decides that the number of error sectors exceeds a prescribed number and that the sectors are consecutive (S14: YES), the verify processing is halted, and the DSP 15 is used to move the optical head 21 to the target track to re-execute the verify processing (S8, S9). That is, the verify processing is re-executed anew.

Thus according to the fifth aspect, when detected errors are due to causes other than those addressed by verify processing itself, and in particular are due to anomalous operation of the disc access mechanism 4, the verify processing itself is re-executed, and so in this case also unnecessary verify processing can be eliminated, and the overall time required for data recording processing can be shortened.

In the data recording processing of this invention, position information is recorded for all error sectors during the initial verify processing, and subsequent verify processing retries as well as erase and write processing retries are performed only for these error sectors. Consequently in retries of each type of processing, when the positions of the plurality of error sectors are dispersed, the optical head 21 is scanned idly over sectors in which errors were not detected and moved to each of the error sectors.

When the distance between adjacent error sectors is comparatively short, it is efficient to scan idly the optical head 21 and move the head to each error sector; but when the distance between adjacent error sectors is comparatively great, such as for example hundreds of sectors, rather than idly scanning the track with the optical head 21 to move to the next error sector, it is more efficient to re-position the optical head 21 at the error sector.

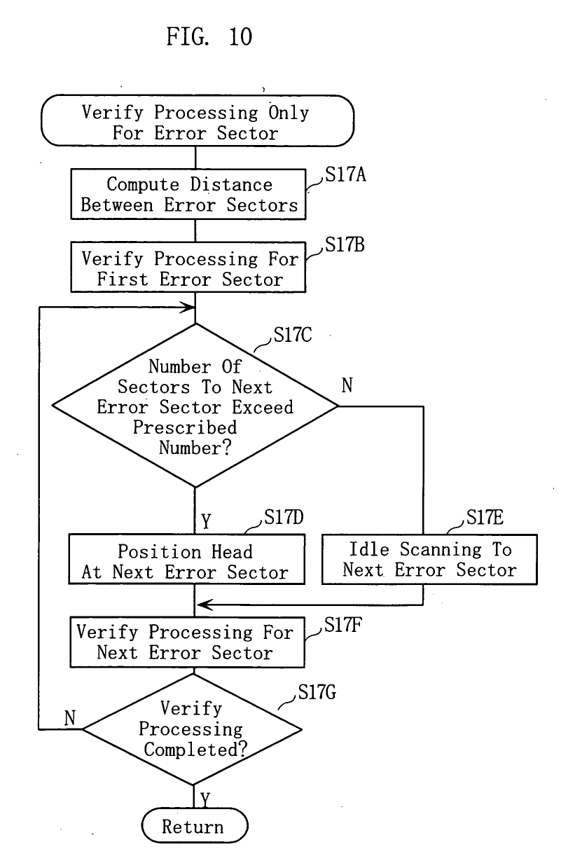

FIG. 10 is a flowchart in which, in the verify processing for only error sectors in step S17 of the flowchart shown in FIG. 4, the efficiency of positioning of the optical head at error sectors is improved.

To explain the flowchart of the figure, in moving from step S16 to step S17, the formatter 14 computes the distance (number of sectors) between each of the error sectors from the error sector position information stored in memory 13 (S17A). Then, the formatter 14 performs verify processing for the first error sector (S17B). The formatter 14 then judges whether the number of sectors to the next error sector is greater than a prescribed number of sectors (S17C). The prescribed number of sectors is stored in advance in memory 13. If the number of sectors to the next error sector is not greater than the prescribed number of sectors (S17C: NO), the formatter 14, via the DSP 15, moves (scans idly) the optical head 21 and magnetic head 22 along the track to the next error sector, and performs verify processing for the next error sector (S17E, S17F).

If on the other hand the number of sectors to the next error sector is greater than the prescribed number of sectors (S17C: YES), the formatter 14, via the DSP 15, moves the optical head 21 and magnetic head 22 in the disc radial direction, based on the position information for the next error sector, to position the heads at the next error sector (S17D), and performs verify processing for the next error sector (S17F).

Next, the formatter 14 judges whether verify processing has been completed for all error sectors (S17G), and if verify processing has not been completed (S17G: NO), processing returns to step S17C and verify processing is performed for the next error sector. If verify processing has been completed (S17G: YES), step 17 in FIG. 4 is skipped, and processing proceeds to step S13 in FIG. 3.

By means of this verify processing, when an error sector for which a verify operation is to be performed is not more distant than a prescribed number of sectors from the next error sector, the optical head 21 and magnetic head 22 are moved along the track to the next error sector; but when an error sector is more distant than a prescribed number of sectors from the next error sector, the optical head 21 and magnetic head 22 are moved to the target track, so that the efficiency of movement to each error sector of the optical head 21 and magnetic head 22 is improved, and the time required for data recording processing can be reduced.

In the above explanation, the prescribed number of sectors (threshold value) for judging the distance between error sectors is held constant; but as stated above, the sector lengths on the magneto-optical disc 2 of this aspect differ between zones, and so threshold values for judging distances between error sectors may be set for each zone, with the threshold values made different for different zones.

That is, sector lengths on the magneto-optical disc 2 are shorter in outer zones, so that the prescribed number of sectors for use in judging distances between error sectors may be set, for each zone, such that the prescribed numbers of sectors in outer zones are greater than the prescribed numbers of sectors in inner zones. By this means, movement of the optical head 21 and magnetic head 22 to each error sector can be performed efficiently, regardless of the recording position on the magneto-optical disc 2.

In the above explanation, the efficiency of movement of the optical head 21 and magnetic head 22 to each error sector during verify processing was explained; but a similar method can also be applied in erase processing and in write processing.

The present invention is not limited to the above embodiments. The design of the specific configurations of the various portions of a magneto-optical disc device of this invention can be modified in various ways.

1. A magneto-optical disc device, which, when recording data onto a recording area including a plurality of specified sectors on a magneto-optical disc, scans with a head portion used for reading data from and writing data to the magneto-optical disc above the recording area and performs processing to write the data, then performs data verification processing to verify correctness of the data written to the recording area for each of the sectors, and upon detecting an error in the data verification processing, modifies output conditions of the head portion in the data write processing and in the data verification processing, and again executes the processing, the magneto-optical disc device comprising:
an error sector position detector for detecting all sectors in which errors occur in the data verification processing, and for storing position information of the sectors on the magneto-optical disc in a memory; and,
a re-execution controller for re-executing the data write processing and the data verification processing only for sectors in which errors have occurred based on the sector position information stored in the memory.

2. The magneto-optical disc device according to claim 1, further comprising an error sector counter for counting the number of sectors in which errors have occurred based on the sector position information stored in the memory during the data verification processing, and a judgment unit for comparing the cumulative value of the number of sectors in which errors have occurred as counted by the error sector counter with a prescribed reference value set in advance, and for judging whether to halt the data verification processing, and wherein, when the judgment unit judges that the data verification processing be halted, the re-execution controller halts the data verification processing, and re-executes the data write processing and the data verification processing.

3. The magneto-optical disc device according to claim 1, further comprising an error sector computing unit for computing the number of sectors in which errors have occurred per prescribed recording area comprising a plurality of sectors, based on the sector position information stored in the memory during the data verification processing, and judgment unit for comparing the number of sectors in which errors have occurred per prescribed recording area computed by the error sector computing unit with a prescribed reference value set in advance, and for judging whether to halt the data verification processing, and wherein, when the judgment unit judges that the data verification processing be halted, the re-execution controller halts the data verification processing, and re-executes the data write processing and the data verification processing.

4. The magneto-optical disc device according to claim 3, further comprising a counter for counting the number of executions of the data write processing and the data verification processing, and a reference value modification unit for increasing the prescribed reference value when the number of executions of the data write processing and the data verification processing as counted by the counter exceeds a prescribed threshold value set in advance.

5. The magneto-optical disc device according to claim 1, further comprising a consecutive error sector computing unit for computing the number of consecutive sectors in which errors have occurred, based on the sector position information stored in the memory during the data verification processing, and a data verification re-processing unit for re-performing the data verification processing anew when the number of sectors computed by the consecutive error sector computing unit exceeds a prescribed threshold value.

6. The magneto-optical disc device according to claim 1, further comprising a recording area modification unit for causing data written to all sectors, including sectors stored in the memory in which errors have been detected, to be recorded in sectors in a storage area different from the specified storage area when an error is detected in the data verification processing after the data write processing which has been re-executed by the re-execution controller a prescribed number of times set in advance.

7. The magneto-optical disc device according to claim 1, further comprising a distance computation unit for computing the distances between sectors in which errors have occurred based on the position information for sectors in which errors have occurred stored in the memory, during the data write processing and the data verification processing re-executed by the re-execution controller, and a head portion movement controller for causing movement of the head portion from a first sector in which an error has occurred to the following second sector in which an error has occurred, when the distance computed by the distance computation unit is equal to or less than a reference value set in advance, by causing scanning over recording areas formed in concentric circular shapes or spiral shapes on the magneto-optical disc, and for directly positioning the head portion at the position of the second sector when the distance computed by the distance computation unit exceeds a reference value set in advance.

8. The magneto-optical disc device according to claim 7, wherein recording areas are formed on the magneto-optical disc such that the distances between sectors are different for each zone formed in the disc radial direction, and the reference value for judging distances between sectors is set to different values for each zone.

9. A method of writing data to a magneto-optical disc, comprising:
a data writing step of scanning, with a head portion for reading data from and writing data to the magneto-optical disc, over recording areas comprising a plurality of specified sectors on the magneto-optical disc and performing processing to write the data;
a data verification step of performing data verification processing to verify, for each of the sectors, the correctness of data written to the recording area; and
a re-execution step, when an error is detected in the data verification step, of modifying the output conditions of the head portion and re-executing the data write processing and the data verification processing;
wherein all sectors in which errors have occurred are detected in the data verification step, position information of the sectors on the magneto-optical disc is stored in a memory, and re-execution of the data write processing and the data verification processing is performed only for those sectors in which errors have occurred which are stored in the memory.

10. The method of writing data to a magneto-optical disc according to claim 9, further comprising a counting step of counting the number of sectors in which errors have occurred, based on the sector position information stored in the memory during the data verification processing, a judgment step of comparing the cumulative value of the number of sectors in which errors have occurred, counted in the counting step, with a prescribed reference value set in advance, and of judging whether to halt the data verification processing, and a step, when it is judged that the data verification processing be halted in the judgment step, of halting the data verification processing, in order to re-execute the data write processing and the data verification processing.

11. The method of writing data to a magneto-optical disc according to claim 9, further comprising a computation step of computing the number of sectors in which errors have occurred per prescribed recording area comprising a plurality of sectors, based on the sector position information stored in the memory during the data verification processing, a judgment step of comparing the number of sectors in which errors have occurred per prescribed recording area computed in the computation step with a prescribed reference value set in advance, and of judging whether to halt the data verification processing, and a step, when in the judgment step it is judged that the data verification processing be halted, of halting the data verification processing, in order to re-execute the data write processing and the data verification processing.

12. The method of writing data to a magneto-optical disc according to claim 11, further comprising a counting step of counting the number of executions of the data write processing and the data verification processing, and a reference value modification step of increasing the prescribed reference value when the number of executions of the data write processing and the data verification processing as counted in the counting step exceeds a prescribed threshold value set in advance.

13. The method of writing data to a magneto-optical disc according to claim 9, further comprising a consecutive error sectors computation step of computing the number of consecutive sectors in which errors have occurred, based on the sector position information stored in the memory during the data verification processing, and a data verification re-processing step of re-performing the data verification processing anew when the number of sectors computed in the consecutive error sectors computation step exceeds a prescribed threshold value.

14. The method of writing data to a magneto-optical disc according to claim 9, further comprising a recording area modification step of causing data written to all sectors, including sectors stored in the memory in which errors have been detected, to be recorded in sectors in a storage area different from the specified storage area, when an error is detected in the data verification processing after the data write processing which has been re-executed a prescribed number of times set in advance.
